(19) United States
(12) Patent Application Publication
(10) Pub. No.: US 2015/0201005 A1
(43) Pub. Date: Jul. 16, 2015

(54) DATA DEPLOYMENT AND STATISTICS TRACKING

(71) Applicant: DATA ACCELERATOR LTD., LONDON (GB)

(72) Inventors: Sean P. Corbett, London (GB); Matthew P. Clothier, London (GB)

(21) Appl. No.: 14/593,308

(22) Filed: Jan. 9, 2015

Related U.S. Application Data
(60) Provisional application No. 61/926,212, filed on Jan. 10, 2014.

(51) Int. Cl. H04L 29/08; H04L 12/26

(52) U.S. Cl. CPC H04L 67/10; H04L 43/04

(57) ABSTRACT

Systems and methods for deploying data to a client device based on collected pre-deployment and deployment statistics. A data determination deployment system can determine whether to deploy data requested by the client device during a session based on the pre-deployment and deployment statistics. Specifically, the data determination deployment system can determine whether the client device has a right to use or access the requested data. The deployment statistics can be used to determine both the data usage amount and the data usage type by the client device of the requested data deployed to the client device during the session. The data deployment determination system can use the determined data usage amount and data usage type to determine whether to stop deploying data to the client device during the session.

### CROSS REFERENCE TO RELATED APPLICATIONS

This application claims the benefit under 35 U.S.C. §119(e) of U.S. Provisional Application No. 61/926,212 filed Jan. 10, 2014, which is hereby incorporated by reference.

### BACKGROUND

As computers and client devices have become more advanced so to have varying types of data and the sizes of varying type of data used and accessed by computers and client devices. Additionally as various types of data have grown in size networks have gown and become more capable of handling the transfer of data of a large size. Specifically, entire applications or operating systems can be transferred to computers or client devices over networks. The networks can be wired or wireless networks.

While networks have become more capable of handling the transferring of data of large sizes, problems still exist with the efficient transfer of data to computers and client devices over networks. Additionally, problems exist with controlling the unwanted usage or piracy of data transferred over networks.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for deploying data to a client device based on collected pre-deployment and deployment statistics. A data determination deployment system can determine whether to deploy data requested by the client device during a session based on the pre-deployment and deployment statistics. Specifically, the data determination deployment system can determine whether the client device has a right to use or access the requested data. The deployment statistics can be used to determine both the data usage amount and the data usage type by the client device of the requested data deployed to the client device during the session. The data deployment determination system can use the determined data usage amount and data usage type to determine whether to stop deploying data to the client device during the session.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for collecting data statistics and deploying data based on the collected statistics.

FIG. 2 depicts a diagram of an example of a system for deploying data based on pre-deployment statistics.

FIG. 3 depicts a diagram of an example of a system for managing the deployment of data during the deployment of the data.

FIG. 4 depicts a diagram of an example of a system for generating bills for the deployment of data during a session.

FIG. 5 depicts a flowchart of an example of a method for determining whether to deploy data to a client device.

FIG. 6 depicts a flowchart of an example of a method for determining whether to continue deploying data to a client device during a session.

FIG. 7 depicts a flowchart of an example of a method for generating a bill for data deployed during a session.

### DETAILED DESCRIPTION

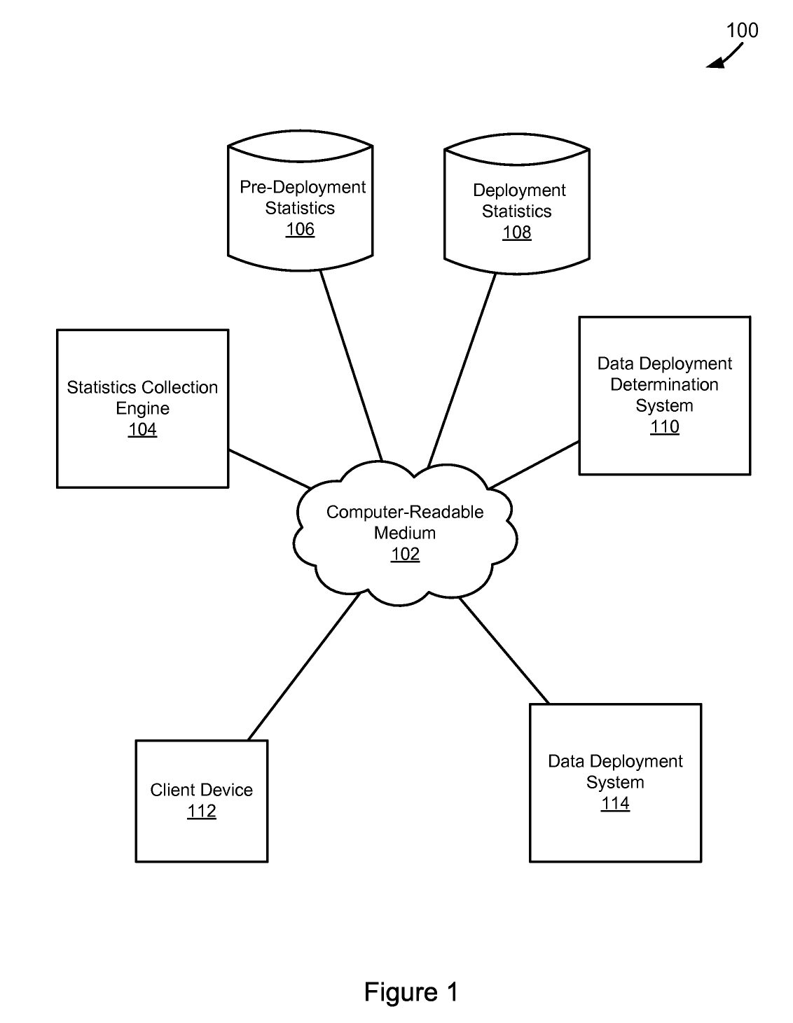

FIG. 1 depicts a diagram 100 of an example of a system for collecting data statistics and deploying data based on the collected statistics. The system of the example of FIG. 1 includes a computer-readable medium 102, a statistics collection engine 104, a pre-deployment statistics datastore 106, a deployment statistics datastore 108, a data deployment determination system 110, a client device 112, and a data deployment system 114.

The statistics collection engine 104, the pre-deployment statistics datastore 106, the deployment statistics datastore 108, the data deployment determination system 110, the client device 112, and the data deployment system 114 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the statistics collection engine 104, the pre-deployment statistics datastore 106, the deployment statistics datastore 108, the data deployment determination system 110, the client device 112, the data deployment system 114, and any other systems, or devices described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described herein.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The data deployment system 114 can function to deploy data to a client device that is associated with or used by a user. The data deployment system 114 can be a data server. More specifically, the data deployment system 114 can be a data server that can be implemented in the cloud as a cloud-based server or any number of data servers that can be implemented in the cloud as cloud-based servers. The data can be distributed across multiple servers. The server can be a server of any type based on the type of data that is provided by the server. For example, the server can be a database server, a file server, a mail server, a print server, a web server, a gaming server, an application server, or an operating system server.

Deploying data can include the initial or continuous transferring or pushing of data during a session. The data can be deployed to the client device 112 after a request for the data is received from the client device 112 or a user associated with the client device 112 by the data deployment determination system 110. The transferring of data to the client device 112 can include streaming the data to the client device 112. A session can include the time during which the data deployment system 114 deploys data to the client device 112 in response to a request for data from a user associated with the client device 112. A session can be of a varying length of time depending on the type of data that is pushed and the client device or the user of the client device, to which the data is being pushed. Furthermore, as will be discussed in greater detail later, a session can be ended before all of the requested data has been deployed to the client device 112. Therefore the length of a session can also vary based on whether the session is ended before all of the requested data has been deployed to the client device 112.

The deployed data can include any data that can be transferred to the client device 112 through the computer-readable medium 102. For example, the data can include values or variables that are stored in a database. The values or variables can be used by software, such as an application or operating system, in execution of the software either on the client device 112 or a cloud based system associated with the client device 112. In another example, the data can include executable computer code. The executable computer code can be software for applications or operating system. The code can be executed on the client device 112 after being deployed to the client device 112 or executed in a cloud based system associated with the client device 112 before it is deployed to the client device 112.

The client device 112 can be a thin client device or an ultra-thin client device. The client device 112 can include a wireless network interface, through which the client device 112 can be coupled to the computer-readable medium 102 through a wireless connection. As a result, the requested data can be wirelessly deployed to the client device 112 over a wireless communication channel.

The statistics collection engine 104 can function to collect and/or generate statistics related to the deployment of data to the client device 112 from the data deployment system 114. The statistics collection engine 104 can collect both pre-deployment statistics and deployment statistics. The pre-deployment statistics and deployment statistics can be stored in the corresponding pre-deployment statistics datastore 106 and the deployment statistics datastore 108.

The pre-deployment statistics and the deployment statistics can be uniquely associated with the client device 112, the user of the client device 112, or the specific data that is being deployed to the client device 112. Additionally, the pre-deployment statistics and the run time statistics can be uniquely associated with a specific session. More specifically, the statistics collected during a previous session can be used to generate pre-deployment statistics for a specific later session of which the generated pre-deployment statistics are associated. For example, the configuration of the client device 112 can be determined during a previous session and used to generate pre-deployment statistics for a later session that describe the configuration of the client device 112. Furthermore, whether or not statistics were collected during a previous session can be used to generate pre-deployment statistics.

Pre-deployment statistics can include statistics that are collected and/or generated before the requested data is deployed to the client device 112 during a specific session. For example, the pre-deployment statistics can include whether or not a client device 112 or a user associated with the client device 112 has a license or the right to access or receive the specific data that is requested for deployment. Additionally, pre-deployment statistics can include whether deployment statistics or pre-deployment statistics were collected in a previous session during which data was deployed to a client device associated with a specific user or the client device 112. For example, the pre-deployment statistics can indicate that deployment statistics were not collected during a previous session in which data was deployed to a client device 112 associated with a specific user. During the previous session, the same data could have been deployed to the client device 112 or different data could have been deployed. For example, the pre-deployment statistics for data of type A can include that deployment statistics were not collected when data of type B, that is different from data of type A, was deployed to the client device 112 during a previous session.

Deployment statistics can include statistics for specific data that are collected and/or generated both while the specific data is deployed for a specific session to the client device 112 and after the specific data is deployed to the client device 112 and still being used by the client device 112. For example, the deployment statistics can include how the deployed data is being used by the user associated with the client device 112. More specifically, if the user is using the deployed data to run queries or perform search filters, the deployment statistics can indicate that the data was used to run queries or perform search filters. In another example, the deployment statistics can include how much time the deployed data is used by the user associated with the client device 112. For example, if the user uses the data for ten minutes, the deployment statistics can indicate that the data was used for ten minutes.

The statistics collection engine 104 can collect and/or generate statistics from the client device 112 itself and/or the data deployment system 114. The statistics collection engine 104 can collect and/or generate both pre-deployment and deployment statistics, before, during, and after deployment of data during a session. In one example, the statistics collection engine 114 can collect statistics that include the configuration of the client device 112 directly from the client device 112 either before deployment of data to the client device or as the data is being used by the client device 112. Additionally the statistics, including the pre-deployment statistics can be generated from the deployment statistics collected from the client device 112 and the data deployment system 114 during a previous session. More specifically, the statistic collection engine 104 can generate statistics that indicated that a user has a license or right to access data if the data was deployed to a client device 112 associated with the user during a previous session. In another example, the statistics collection engine 104 can collect statistics that include the configuration of the deployed data based on the preferences of the user from a previous session in which data of a same or related type is deployed to the client device 112 associated with or used by the user. For example, if the user modified the specific data in a previous session in which the data was deployed to a client device of the user, then the pre-deployment statistics can include these modifications to the data and the corresponding configuration of the data that represents the modifications. The modifications to the data made at the client device 112 can be determined from the client device 112 both as and after the data is deployed to it during the previous session.

Alternatively, the statistics collection engine 104 can collect statistics from systems, engines, or other entities external to the client device and the data deployment system 114. The statistics can be collected before, during, and after deployment of data during a session. Specifically, the statistics collection engine 104 can collect both pre-deployment and deployment statistics from an entity that is responsible for creating and/or providing the data to the data deployment system 114. For example, a software provider can indicate to the statics collection engine 104 that the user associated with the client device 112 is authorized or has the right to access the data. More specifically, the user can be associated with an entity that the provider has granted a right to access the data. This right to access the data can be used to determine whether a user associated with the entity has a right to access the content, which can be collected and stored as pre-deployment statistics, in the pre-deployment statistics datastore 106.

The data deployment determination system 110, can function to determine whether to begin or continue the deployment of data to the client device 112 during a session. Specifically, the data deployment system 110 can instruct the data deployment system 114 to start deploying requested data to the client device 112 during a session in which a request for the data was made by the client device 112 or a user associated with the client device 112. Additionally, the data deployment system 110 can instruct the data deployment system 114 to stop deploying data to a client device 112 as the data deployment system 114 deploys requested data to the client device 112 during a session.

In determining whether to begin or continue the deploying of data to the client device 112 during a session, the data deployment determination system 110 can use the pre-deployment statistics and the deployment statistics stored in the corresponding pre-deployment statistics and deployment statistics datastores 106 and 108. For example, the data deployment determination system 110 can use the pre-deployment statistics or the deployment statistics to determine whether the client device 112 or a user associated with the client device 112 has a license or a right to access requested data. More specifically, if the data deployment determination system 110 determines that the client device 112 or a user associated with the client device 112 has a license or a right to access the requested data, then the data deployment determination system 110 can instruct the data deployment system 114 to begin deploying the requested data to the client device 112. In another example, the data deployment determination system 110 can determine that a user of the client device 112 is using data that is being received during a session in an improper manner. In response, the data deployment determination system can instruct the data deployment system 114 to stop transferring data to the client device 112 and end the session.

In the operation of the example system shown in FIG. 1, the statistics collection engine 104 collects and/or generates both pre-deployment and deployment statistics. The pre-deployment statistics can be stored in the pre-deployment statistics datastore 106, while the deployment statistics can be stored in the deployment statistics datastore 108. The data deployment determination system 110 can use the pre-deployment and deployment statistics to determine whether the data deployment system should begin or continue to deploy data to the client device 112. Additionally, the data deployment determination system 110 can instruct the data deployment system 114 to begin deploying data or stop deploying data to the client device 112.

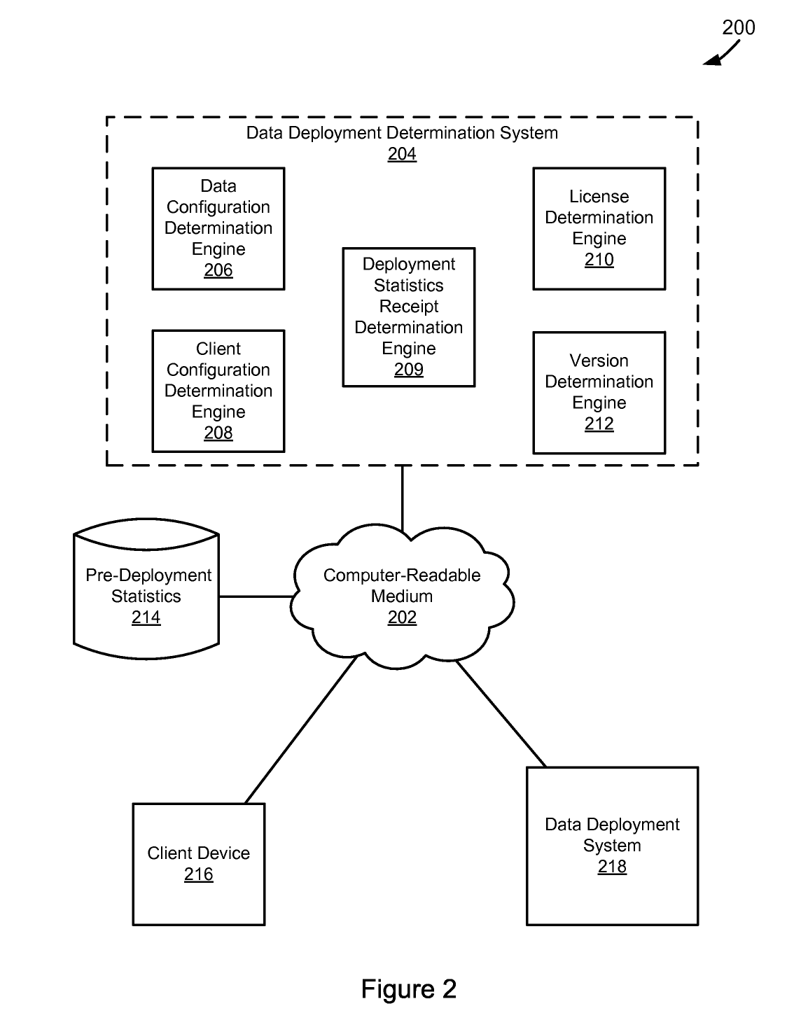

FIG. 2 depicts a diagram 200 of an example of a system for deploying data based on pre-deployment statistics. The system in FIG. 2 includes a computer-readable medium 202, a data deployment determination system 204, a pre-deployment statistics datastore 214, a client device 216, and a data deployment system 218. The data deployment determination system 204, the pre-deployment statistics datastore 214, the client device 216, and the data deployment system 218 are coupled to each other through the computer-readable medium 202.

The client device 216 and the data deployment system 218 can function according to an applicable client device and data deployment system such as is described by way of example in this paper. In operation, the pre-deployment statistics datastore 214 includes pre-deployment statistics. The pre-deployment statistics can include applicable pre-deployment statistics, such as the previously described pre-deployment statistics. The pre-deployment statistics can include what version of requested data the client device or user associated with the client device used during a previous session. The version of the requested data can be collected and/or generated from statistics collected and/or generated for a previous session in which the client device 216 received the same data or data of the same type as is requested in the current session. For example, if either or both the pre-deployment and the deployment statistics for a previous session indicate that data of version A was deployed to the client device 216, then the pre-deployment statistics can reflect that data of version A was sent to the client device 216 in a previous session. If a newer version of the data is available, the data deployment determination system 204 can function to instruct the data deployment system 218 to send a notification to the client device 216 that a new version of the data is available and whether the client device 216 or a user associated with the client device would like to receive the new version of the data instead of the version that was deployed during the previous session.

The pre-deployment statistics stored in the pre-deployment statistics datastore 214 can also include the configuration of the client device 216. The configuration of the client device 216 can be for either the current session or a previous session when data was deployed to the client device 216. For example, the pre-deployment statistics can include the operating parameters of the client device 216 when data was deployed to the client device 216 during a previous session. The data that was deployed to the client device during the previous session can be the same as the data that is requested during the current session or be of the same or a related data type as the data that is requested during the current session. For example, if the requested data is for a word processing application, the pre-deployment statistics can include the configuration of the client device 214 in executing a word processing application deployed during a previous session. Specifically, the pre-deployment statistics can include the configuration of the client device 214 in executing the word processing application deployed during a previous session regardless of whether the word processing application executed during a previous session is the same as the requested word processing application.

The pre-deployment statistics stored in the pre-deployment statistics datastore 214 can also include how the requested data was configured when it was deployed and/or used by the client device 216 during a previous data session. For example, if the requested data was modified or used in a certain way during a previous session by the client device 216, the pre-deployment statistics can include what modifications were made to the requested data during the previous session or how the data was used during the previous session. Additionally, the pre-deployment statistics about the configuration of the data can include what deployed data was used during the previous session and what deployed data was not used during the previous session. Furthermore, the pre-deployment statistics about the configuration of the data can include in what order the data was used by the client device 216.

The data deployment determination system 204 includes a data configuration determination engine 206, a client configuration determination engine 208, a deployment statistics receipt determination engine 209, a license determination engine 210, and a version determination engine 212. The data deployment determination system 204 can function as the data deployment determination system 204 in determining whether to begin or continue deployment data from the data deployment system 218 to the client device 216 during a session. After determining whether to begin or continue deployment of data during a session, the data deployment determination system 204 can function to instruct the data deployment system to begin deploying data, to not deploy data, or to stop deploying data based on the made determination.

The license determination engine 210 can function to determine whether the client device 216 or a user associated with the client device 216 has a license or a right to access the data that is requested during a session. The license determination engine 210 can determine whether the client device 216 or a used associated with the client device 216 has a license to access the requested data from the pre-deployment statistics. In one example, the license determination engine 210 can determine whether a license exists based on pre-deployment statistics that indicate whether the data was deployed to the client device 216 or a user associated with the client device 216 during a previous session. In another example, the license determination engine 210 can determine that a license exists if the pre-deployment statistics indicate that the data was in fact deployed to the client device 216 or a user associated with the client device 216 during a previous session.

Additionally, the license determination engine 210 can determine whether a client device 216 or a user associated with the client device 216 has a license to access the requested data based on pre-deployment statistics collected and or generated from information provided by a third party. The third party can be an entity that has the right to grant a license. For example, the third party can be a data provider or creator.

The license can include an amount of time that the client device 216 or a user associated with the client device 216 has a right to access the requested data. The license determination engine 210 can determine that the client device 216 or a user associated with the client device 216 has a right to access the requested data if the amount of time that is included as part of the license is above a minimum threshold license time. For example, if the minimum threshold license time is 20 minutes, and the license determination engine 210 determines that the client device 216 or the user associated with the client device 216 only has a license to access the requested data for ten minutes, the license determination engine 210 can determine that a valid license does not exist. The minimum threshold license time can be a preset value that is independent of the data type of the requested data or a variable that changes based on the data type of the requested data. For example, the minimum threshold time for a word processing application can be 60 minutes while the minimum threshold time for a media file can be 10 minutes.

After determining that a valid license exists for the requested data, the license determination engine 210 can instruct the data deployment system 218 to begin the deployment of the requested data to the client device 216. Additionally, if the license determination engine 210 determines that the client device 216 or a user associated with the client device 216 does not have a valid license for the requested data, the license determination engine 210 can instruct the data deployment system 218 to send an invalid license notification to the client device 216. The notification can include indicia or text indicating that a valid license does not exist and the option to obtain or purchase a valid license. For example, the notification can include a link to the provider of the requested data through which a valid license can be obtained or purchased.

Additionally, if the license determination engine 210 determines that a valid license exists but it is about to expire, the license determination engine 210 can instruct the data deployment system 218 to send an expiration notification to the client device 216. The expiration notification can include that indicia or text indicating that the license is about to expire and the option to increase the time or usage amount during which the license extends. For example, the notification can include a link to the provider of the requested data through which the license can be extended.

The deployment statistics receipt determination engine 209 can function to determine whether deployment statistics were collected and/or generated from the client device 216 or a user associated with the client device 216 during a previous session. The deployment statistics receipt determination engine 209 can determine whether deployment statistics were collected during a previous session from the pre-deployment statistics stored in the pre-deployment statistics datastore 214. The previous session can be the last session with respect to the present session during which data was deployed to the client device 216.

The deployment statistics receipt determination engine 209 can also function to instruct the data deployment system 218 to either deploy or not deploy the requested data to the client device 216. Specifically, if the deployment statistics receipt determination engine 209 determines that deployment statistics were not collected and/or generated during a previous session, then the deployment statistics receipt determination engine 209 can instruct the data deployment system 218 to not begin deployment of the requested data to the client device 216. Similarly, if the deployment statistics receipt determination engine 209 determines that deployment statistics were collected and/or generated during a previous session, then the deployment statistics receipt determination engine 209 can instruct the data deployment system 218 to begin deployment of the requested data to the client device 216.

The data configuration engine 206 can function to determine the configuration of the requested data that the data deployment system 218 deploys to the client device 216. The data configuration engine 206 can determine the configuration of the requested data from the pre-deployment statistics stored in the pre-deployment statistics datastore 214. More specifically, the pre-deployment statistics can include how the client device 216 modified or used the requested data or data of the same or related data type as the requested data during a previous session. For example, the data configuration engine 206 can determine that the client device 216 only used certain fonts when a word processing application was deployed to the client device 216 during a previous session. In another example, the data configuration engine 206 can determine the order in which the data was used by the client device 216 during the previous session.

The data configuration engine 208 can also function to instruct the data deployment system 218 according to the determined configuration of the data. Specifically, the data configuration engine 208 can instruct the data deployment system 218 to deploy only data of the requested data that was used by the client device 216 during a previous session. For example, if the client device 216 only uses certain fonts when executing a word processing application, the data configuration engine 208 can instruct the data deployment system to only deploy the certain fonts that are used by the client device 216 when executing the word processing application. Additionally, the data configuration engine 208 can instruct the data deployment system 218 to deploy the data in the form that it was modified by the client device 216 during a previous session. Furthermore, the data configuration engine 208 can instruct the data deployment system 218 to deploy the data to the client device 216 in the order in which the client device 216 used the data during a previous session.

The version determination engine 212 can function to determine the version of the requested data for deployment to the client device 216. The version determination engine 212 can determine the version of the requested data from the pre-deployment statistics stored in the pre-deployment statistics datastore 214. For example, the version determination engine 212 can determine the version of the requested data based on the version of data deployed to the client device 216 during a previous session that is the same as the requested data, of the same data type as the requested data or of a related data type as the requested data.

The version determination engine 212 can also function to instruct the data deployment system 218 to deploy the version of the requested data according to the determined version. Additionally, if a newer version of the requested data is available when compared to the determined version of the requested data, the version determination engine 212 can function to instruct the data deployment system 218 to send a notification to the client device 216. The notification can include an indication that a new version of the requested data is available and ask the client device 216 or a user associated with the client device 216 whether they would like to receive the new version of the requested data.

The client configuration determination engine 208 can function to determine the configuration of the client device 216. The configuration can include the operating parameters of the client device 216 including what applications or operating systems or present on or are used by the client device 216. The client configuration determination engine 208 can determine the configuration of the client device 216 from the pre-deployment statistics stored in the pre-deployment statistics datastore 214. For example, the client configuration determination engine 208 can determine the configuration of the client device 216 from the client device 216 itself as it received and used deployed data during a previous session. The data deployed during a previous session, from which the client configuration determination engine 208 can determine the configuration of the client device 216, can be the same, of the same data type, or of a related data type as the requested data of the current session.

The client configuration determination engine 208 can also function to instruct the data deployment system 218 to deploy the requested data to the client device 216 based on the determined configuration of the client device 216. For example, if the requested data requires an application that is not present on the client device 216, the data deployment system 218 can deploy the required application along with the requested data.

In the operation of the example system shown in FIG. 2, the data deployment system 218 can deploy data to the client device 216. The data deployment determination system 204 can control the deployment of data by the data deployment system 218 based on pre-deployment statistics stored in the pre-deployment statistics datastore 214. The data deployment determination system 204 includes a license determination engine 210 that can determine whether the client device 216 or a user associated with the client device 216 has a license to access the requested data. The license determination engine 210 can instruct the data deployment system 218 to begin deploying or not deploy the requested data to the client device based on whether it is determined that the client device 216 or a user associated with the client device 216 has a license to access the requested data.

Further in operation, the deployment statistics receipt determination engine 209 can function to determine whether deployment statistics were received from the client device 216 or a user associated with the client device 216 during a previous session. The deployment statistics receipt determination engine 209 can also function to instruct the data deployment system 218 to begin deploying or not deploy the requested data based on whether it is determined that deployment statistics were received during a previous session. The version determination engine 212, in operation, can function to determine the version of the requested data. The version determination engine 212 can also function to instruct the data deployment system 218 to deploy the requested data based on the determined version. In operation, the data configuration determination engine 206 can function to determine the configuration of the requested data. The data configuration determination engine 206 can also function to instruct the data deployment system 218 to deploy the requested data based on the determined data configuration. Further in operation, the client configuration determination system 208 can function to determine the configuration of the client device 216. The client configuration determination system 208 can also function to instruct the data deployment system 218 to deploy the requested data based on the determined client configuration.

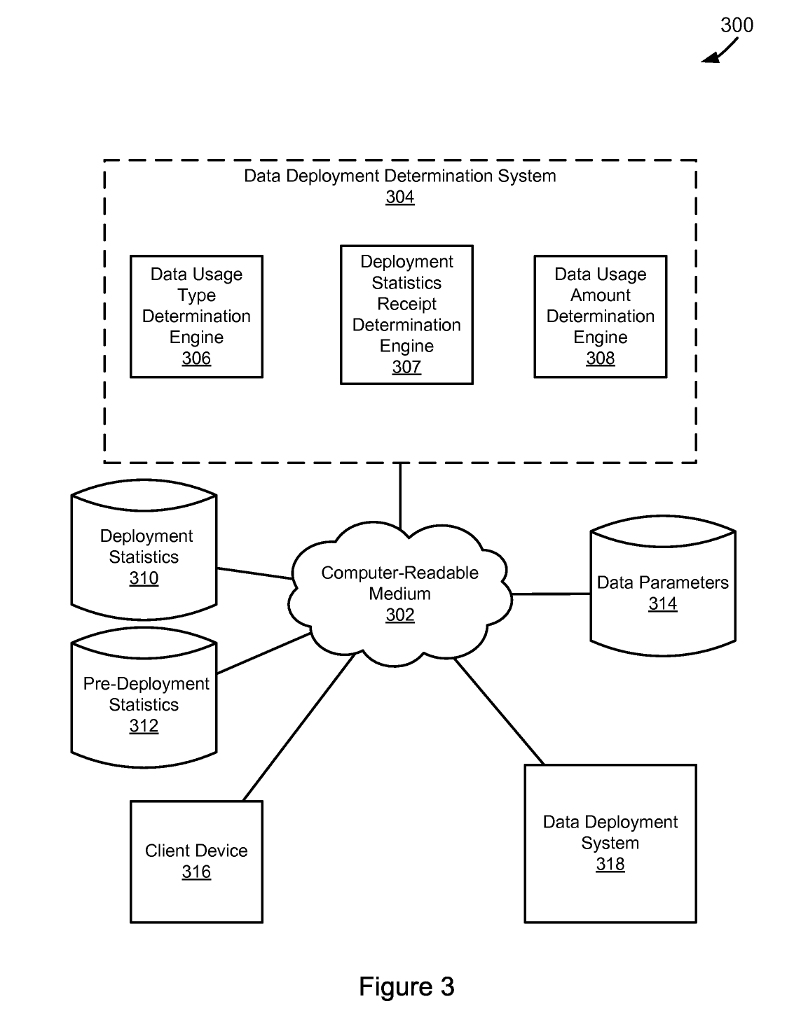

FIG. 3 depicts a diagram 300 of an example of a system for managing the deployment of data during the deployment of the data. The system of FIG. 3 includes a computer-readable medium 302, a data deployment determination system 304, a deployment statistics datastore 310, a pre-deployment statistics datastore 312, a data parameters datastore 314, a client device 316, and a data deployment system 318. The data deployment determination system 304, the deployment statistics datastore 310, the pre-deployment statistics datastore 312, the data parameters datastore 314, the client device 316, and the data deployment system 318 are coupled to each other through the computer-readable medium 302.

The client device 316 and the data deployment system 318 can function according to any client device and data deployment system described in this paper. Specifically, the data deployment system 318 can function to deploy data to the client device 316. The deployment statistics datastore 310 and the pre-deployment statistics datastore 312 can store deployment statistics and pre-deployment statistics. The deployment statistics and the pre-deployment statistics can include any corresponding deployment or pre-deployment statistics described in this paper.

Data usage parameters can be stored in the data parameters datastore 314. Data usage parameters can include what the acceptable usage type of the data is. For example, the data usage parameters can include that the data can be used to perform certain functions and not be used to perform other functions. More specifically, the data usage parameters can specify that the data is not to be used for performing illegal activities such as the theft of copyrighted material. In another example, the data usage parameters can specify various applications in which the data can and cannot be used. For example, the data usage parameters can specific that the data cannot be used with a specific word processing application. The data usage parameters can be set by the provider of the data or the creators of the data.

The data deployment determination system 304 includes a data usage type determination engine 306. The data usage type determination engine 306 can function to determine how the deployed data is being used or accessed both before and after deployment of the data. The data usage type determination engine 306 can use the deployment statistics stored in the deployment statistics datastore 310 to determine how the data is being used during and after a session. For example, the data usage type determination engine 306 can determine that the client device 316 is using the data to execute a word processing application from the deployment statistics.

The data usage type determination engine 306 can also function to determine whether the data is being used in an acceptable or allowable manner or to perform an acceptable or allowable function. Specifically, the data usage type determination engine 306 can compare the determined usage type of the data to the data usage parameters stored in the data parameters datastore 314 to determine whether the data is being used in an acceptable manner or to perform an acceptable function. For example, if the data usage parameters specify that the data is not to be used with a specific application, and it is determined that the client device 316 is in fact using the data with the specific application, then the data usage type determination engine 306 can determine that the data is not being used in an acceptable manner. In another example, if the data usage parameters specify that the data is not to be used to download copyrighted material, and it is determined that the client device 316 is in fact using the data to download copyrighted material, then the data usage type determination engine 306 can determine that the data is not being used in an acceptable manner.

Additionally, the data usage type determination engine 306 can function to instruct the data deployment system 318 to stop the deployment of data to the client device 316 during a session. Specifically, the data usage type determination engine 306 can instruct the data deployment system 318 to stop the deployment of data, if it is determined that the deployed data is not being used in an acceptable manner or is not being used to perform an allowable function. Furthermore, the data usage type determination engine 306 can also instruct the data deployment system 318 to send a stop deployment notification to the client device 316. The stop deployment notification can inform the client device 316 or a user associated with the client device 316 that data is no longer being deployed to the client device during the current session. The stop deployment notification can also include the identification of the data used in an unacceptable manner or to perform an unacceptable function.

Furthermore, the data usage type determination engine 306 can also function to instruct the data deployment system 318 to not deploy data to the client device 316 or a user associated with the client device 316 in future sessions. Specifically, the data usage type determination engine 306 can instruct the data deployment system 318 to not deploy data to the client device 316 for a certain amount of time or for a certain number of requests for data or session after the present session.

Additionally, the data usage type determination engine 306 can generate a deployment statistic that indicates that the client device 316 or a user associated with the client device 316 is flagged for using the data in an inappropriate manner. The flag that is included as part of the deployment statistics can be used to generate pre-deployment statistics in different sessions. The data deployment determination system 304 can use the pre-deployment statistics in different session to determine whether or not the client device 316 or a user associated with the client device has been flagged for inappropriate data usage. The data deployment determination system 304 can instruct the data deployment system 318 to not begin deploying data to the client device 316 if it is determined that the client device 316 or a user associated with the client device 316 has been flagged for inappropriate data usage. Alternatively, the data deployment determination system 304 can instruct the data deployment system 318 to not begin deploying data to the client device 316 if it is determined that the client device 316 or a user associated with the client device 316 has been flagged for inappropriate data usage a specific number of times over a flag threshold. For example, if it is determined that the client device 316 has been flagged for inappropriate data usage four times and the flag threshold is three times, then the data usage type determination engine can instruct the data deployment system 316 to not begin deployment of data during a session. The flag threshold can be a variable that changes based on the client device 316 or a user associated with the client device 316 that requested the data for deployment. Alternatively, the flag threshold can be a value that is set by a system administrator.

The data deployment determination system 304 also includes a data usage amount determination engine 308. The data usage amount determination engine 308 can function to determine the actual amount of usage of or access to the deployed data by the client device 316. For example, the data usage amount determination engine 308 can determine that the client device 316 is using the deployed data for a specific amount of time, such as ten minutes. In another example, the data usage amount determination engine 308 can determine the number of times that the client device 316 has used or accessed the deployed data, e.g. ten times. The data usage amount determination engine 308 can function with the data usage type determination engine 306 to determine how the client device 316 used the deployed data and for how long the deployed data was used in the determined manner.

The data usage amount determination engine 308 can also function to determine whether or not the client device 316 or a user associated with the client device 316 has exceeded the allowable amount of usage of the deployed data granted through a license. Specifically, the data usage amount determination engine 308 can determine from pre-deployment statistics stored in the pre-deployment statistics datastore 312, the amount of usage of or access to the deployed data that the client device 316 was granted through the license. The amount of usage of or access to the deployed data that the client device 316 was granted can include a specific number of times or a specific amount of time. The data usage amount determination engine 308 can compare the determined actual data usage amount with the amount of usage that the client device 316 was granted through the license to determine whether the client device 316 has exceeded the granted amount of usage.

If the determined data usage amount exceeds the granted usage amount, then the data usage amount determination engine 308 can instruct the data deployment system 318 to stop the deployment of data to the client device 316. For example, if the data usage amount determination engine 308 determines that the client device 316 or a user associated with the client device 316 has accessed the deployed data for 10 minutes and was only granted a right to access the data for 5 minutes, then the data usage amount determination engine 308 can instruct the data deployment system 318 to stop the deployment of data to the client device 316.

The data deployment system 318 can include a deployment statistics receipt determination engine 307. The deployment statistics receipt determination engine 307 can function in the same way as the deployment statistics receipt determination engine described in FIG. 2. Additionally, the deployment statistics receipt determination engine 307 can function to determine whether deployment statistics are received during a session, while data is deployed to the client device 316 during the session. The deployment statistics receipt determination engine can also function to instruct the data deployment system 318 to stop deployment of data to the client device 316 if it determines that deployment statistics are not being received during the session.

In the operation of the example system shown in FIG. 3, the data deployment system 318 can deploy data to the client device 316. The data deployment determination system 304 can control the deployment of data by the data deployment system 318 based on deployment and pre-deployment statistics stored in the deployment statistics datastore 310 and the pre-deployment statistics datastore 312. Furthermore, the data deployment determination system 304 can control the deployment of data by the data deployment system 318 based on data usage parameters stored in the data parameters datastore 314.

More specifically, the data deployment determination system 204 includes a data usage type determination engine 306, that in operation, can function to determine how the client device 316 or a user associated with the client device 316 uses the deployed data. Further in operation, the data usage type determination engine 306 can function to compare the determined usage type of the deployed data with the data usage parameters in the data parameters datastore 314 to determine whether the client device 316 or a user associated with the client device 316 is using the deployed data in an acceptable manner. If the data usage type determination engine 306 determined that the client device 316 or a user associated with the client device is using the deployed data in an unacceptable manner, then the data usage type determination engine 306 can instruct the data deployment system to stop the deployment of data to the client device 316. Furthermore, the data deployment determination system 204 includes a data usage amount determination engine 308 that in operation can function to determine the amount of usage of the deployed data by the client device 316 or a user associated with the client device 316. The data usage amount determination engine 308 can also function to compare the determined usage amount with the allowed usage amount that was granted through a license to the client device 316 or a user of the client device 316 to determine whether the actual usage amount exceeds the allowed usage amount. If the data usage amount determination engine 308 determines that the actual usage amount exceeds the allowed usage amount, then the data usage amount determination engine 308 can instruct the data deployment system 318 to stop deployment of data to the client device 316.

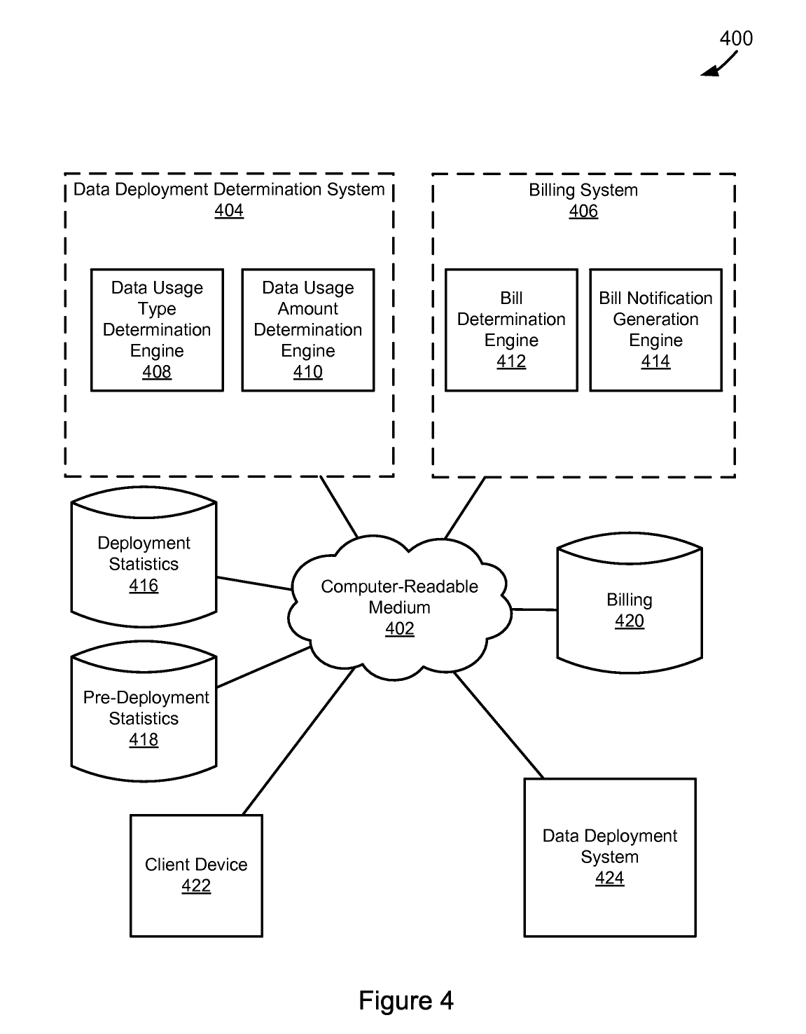

FIG. 4 depicts a diagram 400 of an example of a system for generating bills for the deployment of data during a session. The system of FIG. 4 includes a computer-readable medium 402, a data deployment determination system 404, a billing system 406, a deployment statistics datastore 416, a pre-deployment statistics datastore 418, a billing datastore 420, a client device 422, and a data deployment system 424. The data deployment determination system 404, the billing system 406, the deployment statistics datastore 416, the pre-deployment statistics datastore 418, the billing datastore 420, the client device 422, and the data deployment system 424 are all coupled to each other through the computer-readable medium 402.

The client device 422 and the data deployment system 424 can function according to any client device and data deployment system described in this paper. Specifically, the data deployment system 424 can function to deploy data to the client device 422. The deployment statistics datastore 416 and the pre-deployment statistics datastore 418 can store deployment statistics and pre-deployment statistics. The deployment statistics and the pre-deployment statistics can include any corresponding deployment or pre-deployment statistics described in this paper.

The data deployment determination system 404 includes a data usage type determination engine 408 and a data usage amount determination engine 410. The data usage type determination engine 408 can function according to the data usage type determination engine described in FIG. 3. Specifically, the data usage type determination engine 408 can function to determine how the deployed data is being used or accessed by the client device 422 or a user associated with the client device 422. The data usage amount determination engine 410 can function according to the data usage amount determination engine described in FIG. 3. Specifically, the data usage amount determination engine 410 can function to determine the actual amount of usage of or access to the deployed data by the client device 422.

The billing datastore 420 can store billing parameters. The billing parameters can include the billing rate for the usage of or access to data that is deployed by the data deployment system 424. The billing parameters can be unique to each of the deployed data or unique to data based on the type of data. For example the billing rate can be one dollar per minute for access to or usage of data of type A and two dollars per minute for access to or usage of data of type B. Additionally, the billing parameters include billing rates that can vary for data based on how the data is used. For example, the billing rate can be one dollar per minute for using the data to perform database searches and two dollars per minute for using the data to generate customer relationship models.

The billing system 406 includes a bill determination engine 412. The bill determination engine can function to generate a bill for data deployed to the client device 422 based on the collected deployment statistics and pre-deployment statistics stored in the corresponding deployment statistics datastore 416 and pre-deployment statistics datastore 418. Specifically, in generating a bill, the bill determination engine 412 can use the amount of actual data usage of or access to the deployed data by the client device 422, as determined by the data usage amount determination engine 410. Furthermore, in generating a bill, the bill determination engine 412 can use the actual data usage type of the deployed data by the client device 422, as determined by the data usage type determination engine 408. Furthermore, the bill determination engine 412 can use the billing parameters stored in the billing datastore 420 in combination with the determined data usage amount and type to generate the bill. For example, if the billing parameters indicate that the billing rate for the deployed data is one dollar per minute of use, and the data usage amount determination engine 410 determines that the client device 422 has been using the deployed data for thirty minutes, then the bill determination engine 412 can generate a bill of thirty dollars. In another example, if the billing parameters indicate that the billing rate for the specific usage of the deployed data is one dollar a minute for usage type A and two dollars a minute for usage type B, and the data usage type determination engine 408 and the data usage amount determination engine 410 determine that the client device 422 used the deployed data according to type A for ten minutes and type B for ten minutes, then the bill determination engine 412 can generate a bill of thirty dollars.

The bill determination engine 412 can also function to generate the bill for data deployed to the client device 422 based on pre-deployment statistics stored in the pre-deployment statistics datastore 418. Specifically, the bill determination engine 412 can use the pre-deployment statistics to determine the amount of usage and type of usage of the deployed data that the client device 422 or a user associated with the client device 422 is granted through the license. The bill determination engine can compare the actual data usage amount and type determined by the data usage type determination engine 408 and the data usage amount determination engine 410 with the granted data usage amount and type determined from the license to determine whether the actual usage amount and type of the client device 422 exceeds the granted usage amount and type granted by the license. If the actual data usage amount and type exceeds the granted usage amount and type, then the bill determination engine 412 can generate the bill based on the actual data usage amount and type that exceeds the granted data usage amount and type. In generating the bill based on the actual data usage amount and type that exceeds the granted data usage amount and type, the bill determination engine 406 can use the billing parameters stored in the billing datastore 420. For example, if the bill determination engine 412 determines that the client device's 422 actual usage of the deployed data exceeded the granted amount of usage of the deployed data by ten minutes, and the billing rate for the data type is one dollar per minute, then the bill determination engine 412 can generate a bill of ten dollars.

The billing system 406 also includes a bill notification generation engine 414. The bill notification generation engine 414 can function to generate bill notifications for the bills generated by the bill determination engine 412. The bill notifications can include the billing rates for the deployed data, the amount and types of usage by the client device 422 and the billed amounts for deployed data usage. The bill notification generation engine 414 can send the bill notifications to the client device 422. Additionally the bill notification generation engine 414 can send the bill notifications to the data provider, the data creator, and the system manager. The bill notification generation engine 414 can also be configured to resend the bill notifications to the client device 422 at specific times. For example, the bill notification generation engine 414 can be configured to resend a bill notification to the client device 422 once the bill becomes past due.

In the operation of the example system shown in FIG. 4, the data deployment system 424 can deploy data to the client device 422. The billing system 406 includes a bill determination engine 412 that can generate bills for deployed data usage amount and type by the client device 422 from the deployment statistics stored in the deployment statistics datastore 416. Specifically, the bill determination engine 412 can generate bills based on data usage amount and type determined by the data usage type determination engine 408 and the data usage amount determination engine 410 in the data deployment determination system 404. The bill determination engine 412 can also function to generate bills based on pre-deployment statistics stored in the pre-deployment statistics datastore 418. In generating the bills based on either or both the pre-deployment statistics and the deployment statistics, the bill determination engine 412 can use billing parameters stored in the bill datastore 420. The billing system 406 includes a bill notification generation engine that can generate and send bill notifications based on the bills generated by the bill determination engine 412.

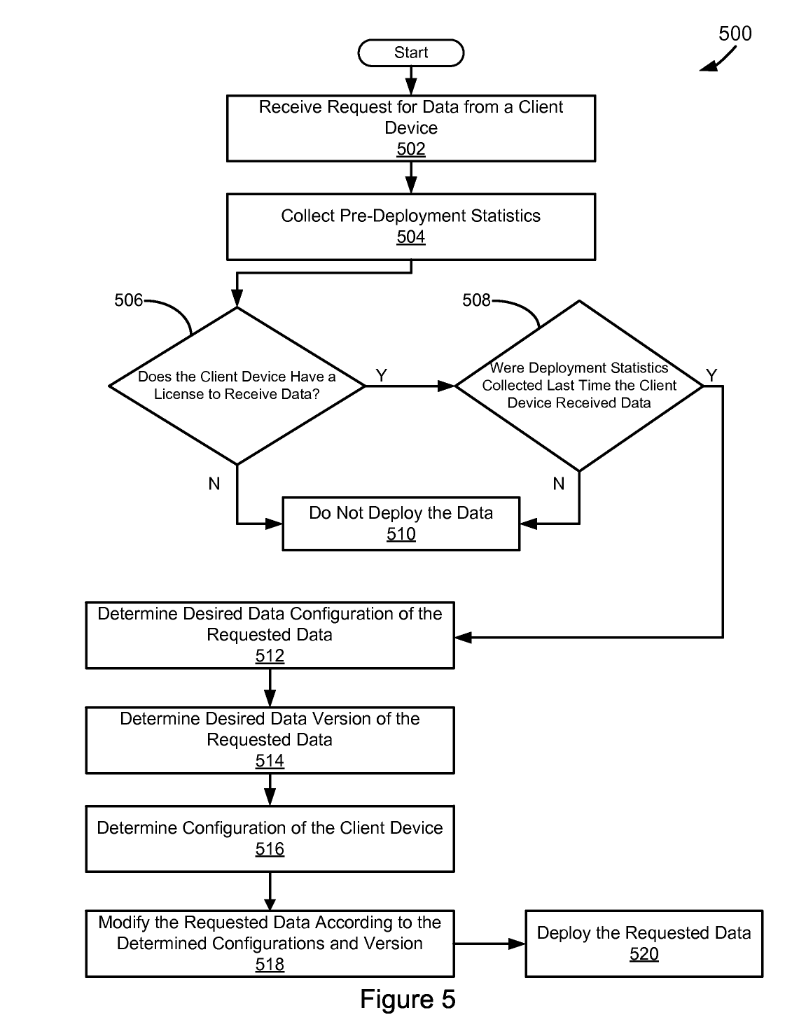

FIG. 5 depicts a flowchart 500 of an example of a method for determining whether to deploy data to a client device. The flowchart 500 begins at module 502 with receiving a request for data from a client device. The request can specify the data to be deployed to the client device from a data deployment system.

In the example of FIG. 5, the flowchart 500 continues to module 504, which includes collecting pre-deployment statistics. The pre-deployment statistics can include any of the pre-deployment statistics described in this paper. The pre-deployment statistics can be collected from the client device itself or systems or sources external to the client device.

In the example of FIG. 5, the flowchart 500 continues to decision point 506 where it is determined whether the client device or a user associated with the client device has a license to receive data. Whether the client device or a user associated with the client device has a license to receive data can be determined from the pre-deployment statistics collected at module 504. If it is determined at decision point 506 that the client device does not have a license to receive the requested data, then the flowchart 500 ends at module 508, where data requested at module 502 is not deployed to the client device. It may be noted that although the flowchart 500 ends at module 508, the flowchart 500 ending is conceptual; this does not necessarily have any impact on parallel or other processes.

If, on the other hand, it is determined at decision point 506 that the client device has a license to receive the requested data, the flowchart 500 continues to decision point 510. At decision point 510, it is determined whether deployment statistics were collected the last time the client device received data. If it is determined at decision point 510 that deployment statistics were not received, then the flowchart 500 ends at module 508, where data is not deployed to the client device. If it is determined at decision point 510 that deployment statistics were received, then the flowchart 500 continues to module 512. At module 512, the desired data configuration of the requested data by the client device or a user associated with the client device is determined. The desired data configuration can include whether any changes to the data are required by the client device requesting the data. The desired data configuration can be determined from the deployment statistics from a previous session in which the requested data was deployed to the client device.

In the example of FIG. 5, the flowchart 500 continues to module 514 where the desired version of the requested data by the client device or a user associated with the client device is determined. The desired version of the requested data can be determined from the pre-deployment statistics and the deployment statistics of a previous session in which the requested data was deployed to the client device. Specifically, the desired version can be determined from the version of the requested data that was deployed to the client device during the previous session. Additionally, determining the desired version of the requested data can include asking the client device or a user associated with the client device whether they want to receive a new version of the requested data, if a newer version of the requested data as compared to the version of the requested data that was deployed during the previous session is available.

In the example of FIG. 5, the flowchart 500 continues to module 516 where the configuration of the client device requesting the data is determined. The configuration of the client device can include what operating systems and applications are available on the client device. The configuration of the client device can also include the hardware specification of the device, such as the amount of RAM and available RAM on the device. The flowchart continues to module 518 where the requested data is modified according to the desired data configuration determined at module 512, the desired version configuration determined at module 514, and the client device configuration determined at module 516. For example, if a specific operating system is utilized or is present on the client device, then the requested data can be modified according to allow for the use or access of the requested data using the specific operating system. In another example, the requested data can be modified to be in the desired version of the requested data. Modifying the requested data can also include instructing the data deployment system to deploy the requested data based on the determined data configuration, client configuration and version. For example, if the requested data is a word processing application and the data configuration includes that the word processing application is changed to only include certain fonts, then the data deployment system can be instructed to deploy the word processing program with only the certain fonts. The flowchart continues to module 518, where the requested data is deployed to the client in its modified form.

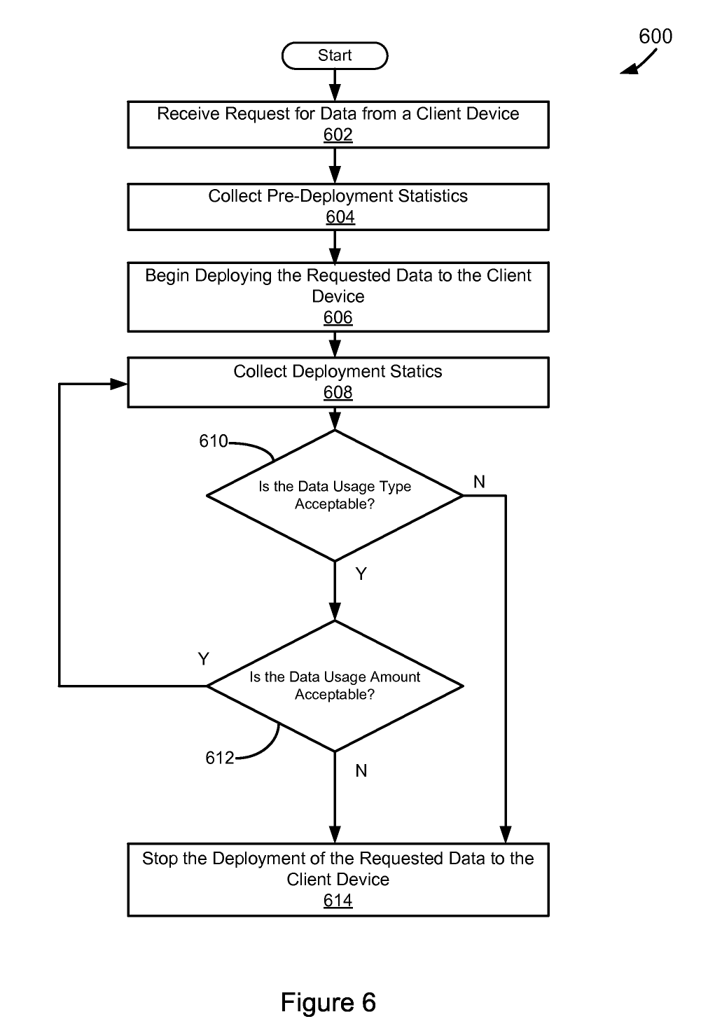

FIG. 6 depicts a flowchart 600 of an example of a method for determining whether to continue deploying data to a client device during a session. The flowchart 600 begins at module 602, where a request for data is received from a client device.

In the example of FIG. 6, the flowchart 600 continues to module 604, where pre-deployment statistics are collected. The pre-deployment statistics can include any of the pre-deployment statistics described in this paper. The flowchart 600 continues to module 606, where the requested data is begun to be deployed to the client device. The flowchart 600 continues to module 608, where deployment statistics are collected. The deployment statistics can include any of the deployment statistics described in this paper and can be collected from the client device requesting the data.

In the example of FIG. 6, the flowchart 600 continues to decision point 610 where it is determined if the data usage type of the deployed data by the client device is acceptable. Whether the data usage type of the deployed data is acceptable can be determined from deployment statistics collected at module 608, pre-deployment statistics collected at module 604 and data stored in the data parameters datastore discussed in FIG. 3. The data usage type can include how the data is being used by the client device. For example, if the client device is using the data to run a word processing application, then the data usage type can be that the data is being used to run a word processing application. If it is determined that the data usage type is not acceptable, then the flowchart 600 continues to module 614 where the deployment of the requested data to the client device is stopped. Alternatively, if it is determined at decision point 610 that the data usage type is acceptable, then the flowchart 600 continues to decision point 612.

At decision point 612 it is determined whether the data usage amount is acceptable. Whether the data usage amount is acceptable can be determined from the pre-deployment statistics collected at module 604 and the deployment statistics collected at module 608. If it is determined that the data usage amount is unacceptable, i.e. the actual data usage amount has exceeded the granted data usage amount, then the flowchart continues to module 614 where the deployment of the requested data to the client device is stopped. Alternatively, if it is determined that the data usage amount is acceptable, then the flowchart 600 continues back to module 608 where more deployment statistics are collected and decision point 610 is repeated.

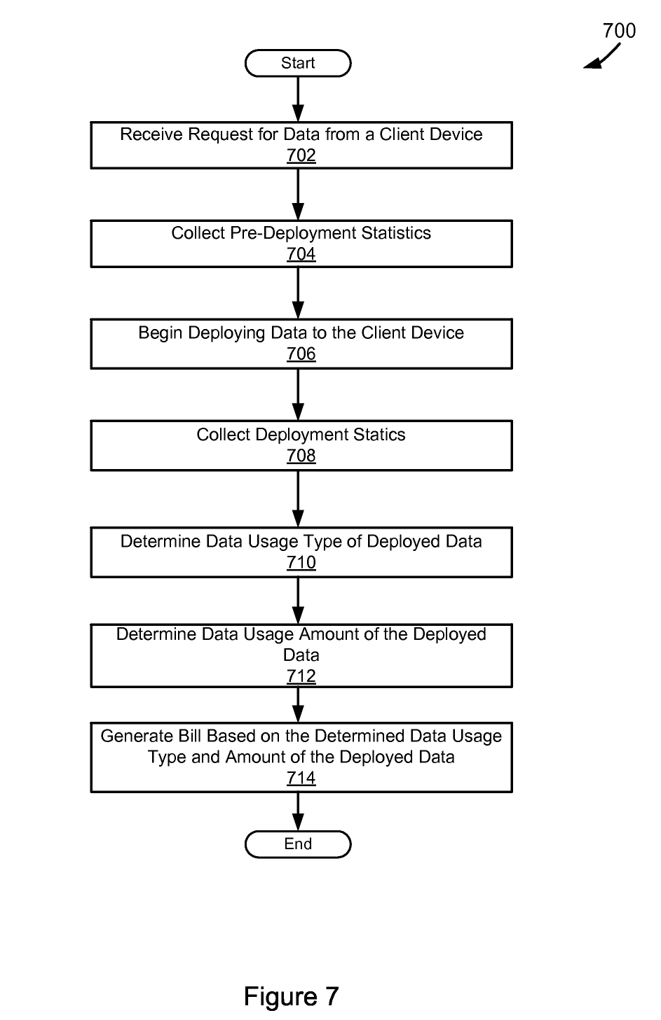

FIG. 7 depicts a flowchart 700 of an example of a method for generating a bill for data deployed during a session. The flowchart 700 begins at module 702, where a request for data is received from a client device.

In the example of FIG. 7, the flowchart 700 continues to module 704, where pre-deployment statistics are collected. The pre-deployment statistics can include any of the pre-deployment statistics described in this paper. The flowchart 700 continues to module 706 where the requested data is begun to be deployed to the client device. The flowchart 700 continues to module 708 where deployment statistics are collected. The deployment statistics can include any of the deployment statistics described in this paper.

In the example of FIG. 7, the flowchart 700 continues to module 710 where the data usage type by the client device of the deployed data is determined. The usage type can be determined from the deployment statistics collected at module 708. Furthermore, the data usage type can be determined while the data is being deployed or after all of the requested data is deployed. The flowchart 700 continues to module 712 where the data usage amount by the client device of the deployed data is determined. The data usage amount can be determined from the deployment statistics collected at module 708. Furthermore, the data usage amount can be determined while the data is being deployed or after all of the requested data is deployed.

In the example of FIG. 7, the flowchart 700 continues to module 714 where a bill is generated based on the data usage type determined at module 710 and the data usage amount determined at module 712. The bill can be generated based on the pre-deployment statistics collected at module 704 and billing parameters. The billing parameters can include any of the billing parameters described in this paper. In using the pre-deployment statistics at module 714 to generate a bill, it can be determined whether or not the license granted to the client device or a user associated with the client device covers the determined data usage amount and data usage type. More specifically, the license that is included as part of the pre-deployment statistics can be used to determine a granted data usage amount and type. Based on the determined granted data usage amount and type, it can be determined the amount of determined actual data usage amount and type that exceeds the granted data usage amount and type. The bill can then be generated at module 714 based on the actual data usage amount and type that exceeds the granted data usage amount and type. The generated bill can be used to generate a bill notification that can be sent to the client device, a user associated with the client device, and a data provider.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving a request for data from a client device during a session;
collecting pre-deployment statistics for the session;
deploying, by a data deployment system, the requested data to the client device during the session;
collecting deployment statistics as the requested data is deployed to the client device during the session;
determining, based on the collected deployment statistics by a data usage type determination engine, data usage type by the client device of the requested data deployed during the session;
determining whether the data usage type by the client device of the requested data deployed during the session is acceptable based on data usage parameters;
stopping deployment of the requested data, by the data deployment system, to the client device if it is determined that the data usage type by the client device of the requested data deployed during the session is unacceptable.

2. The method of claim 1, further comprising, instructing the data deployment system to not deploy data to the client device if a second request for data is received from the client device and it is determined that the data usage type by the client device of the requested data deployed during the session is unacceptable.

3. The method of claim 1, further comprising:
determining, based on the collected deployment statistics by a data usage amount determination engine, data usage amount by the client device of the requested data deployed during the session;
determining whether the data usage amount by the client device of the requested data deployed during the session has exceeded a granted data usage amount, the granted data usage amount determined from the pre-deployment statistics for the session.
stopping deployment of the requested data to the client device if it is determined that the data usage amount by the client device of the requested data deployed during the session has exceeded the granted data usage amount.

4. The method of claim 3, further comprising, instructing the data deployment system to not deploy data to the client device if a second request for data is received from the client device and it is determined that the data usage amount by the client device of the requested data deployed during the session has exceeded a granted data usage amount.

5. The method of claim 1, wherein the requested data is executable code.

6. The method of claim 3, further comprising, generating a bill based on billing parameters and either or both the data usage type and the data usage amount by the client device of the requested data deployed during the session.

7. The method of claim 6, wherein the billing parameters include billing rates for using the requested data that vary based on the data usage type.

8. The method of claim 1, further comprising:
determining a configuration of the requested data from the pre-deployment statistics;
modifying the requested data according to the determined configuration of the requested data before deploying the requested data to the client device during the session.

9. The method of claim 1, further comprising:
determining a version of the requested data from the pre-deployment statistics;
modifying the requested data according to the determined version of the requested data before deploying the requested data to the client device during the session.

10. The method of claim 1, further comprising:
determining a configuration of the client device from the pre-deployment statistics;
modifying the requested data according to the determined configuration of the client device before deploying the requested data to the client device during the session.

11. A system comprising:
a data deployment system configured to deploy data during a session based on a request for data received from a client device;
a statistics collection engine configured to collect pre-deployment statistics and deployment statistics during the session;
a data usage type determination engine configured to determine data usage type by the client of the requested data during the session based on the collected deployment statistics;
a data deployment determination system configured to:
instruct the data deployment system to deploy the requested data to the client device;
determine whether the determined data usage type by the client device of the requested data deployed during the session is acceptable based on data usage parameters;
instruct the data deployment system to stop deploying the requested data to the client device if it is determined that the data usage type by the client device of the requested data deployed during the session is unacceptable.

12. The system of claim 11, wherein the data deployment determination system is further configured to instruct the data deployment system to not deploy data to the client device if a second request for data is received from the client device and it is determined that the data usage type by the client device of the requested data deployed during the session is unacceptable.

13. The system of claim 11, further comprising:
a data usage amount determination engine configured to determine data usage amount by the client of the requested data deployed during the session based on the collected deployment statistics;
the data deployment determination system further configured to:
determine whether the determined data usage amount by the client device of the requested data deployed during the session has exceeded a granted data usage amount, the granted data usage amount determined from the collected pre-deployment statistics for the session;
instruct the data deployment system to stop deployment of the requested data to the client device if it is determined that the data usage amount by the client device of the requested data deployed during the session has exceeded the granted data usage amount.

14. The system of claim 13, wherein the data deployment system is further configured to instruct the data deployment system to not deploy data to the client device if a second request for data is received from the client device and it is determined that the data usage amount by the client device of the requested data deployed during the session has exceeded a granted data usage amount.

15. The system of claim 13, further including a billing system configured to generate a bill based on billing parameters and either or both the data usage type and the data usage amount by the client device of the requested data deployed during the session.

16. The system of claim 15, wherein the billing parameters include billing rates for using the requested data that vary based on the data usage type.

17. The system of claim 11, further comprising, a data configuration determination engine configured to:
determine a configuration of the requested data from the pre-deployment statistics;
modify the requested data according to the determined configuration of the requested data before the data deployment determination system instructs the data deployment system to begin deploying the requested data to the client device.

18. The system of claim 11, further comprising, a version determination engine configured to:
determine a version of the requested data from the pre-deployment statistics;
modify the requested data according to the determined version of the requested data before the data deployment determination system instructs the data deployment system to begin deploying the requested data to the client device.

19. The system of claim 11, further comprising, a client configuration determination engine configured to:
determine a configuration of the client device from the pre-deployment statistics;
modify the requested data according to the determined configuration of the client device before the data deployment determination system instructs the data deployment system to begin deploying the requested data to the client device.

20. A system comprising:
means for receiving a request for data from a client device during a session;
means for collecting pre-deployment statistics for the session;
means for deploying the requested data to the client device during the session;
means for collecting deployment statistics as the requested data is deployed to the client device during the session;
means for determining, based on the collected deployment statistics, data usage type by the client device of the requested data deployed during the session;
means for determining whether the data usage type by the client device of the requested data deployed during the session is acceptable based on data usage parameters;
means for stopping deployment of the requested data to the client device if it is determined that the data usage type by the client device of the requested data deployed during the session is unacceptable.
